(19) United States
(12) Patent Application Publication
(10) Pub. No.: US 2022/0196379 A1
(43) Pub. Date: Jun. 23, 2022

(54) DEVICE AND A METHOD FOR TRAINING A NEURAL NETWORK FOR DETERMINING A ROTATION ANGLE OF AN OBJECT, AND A DEVICE, A SYSTEM AND A METHOD FOR DETERMINING A ROTATION ANGLE OF AN OBJECT

(71) Applicant: Infineon Technologies AG, Neubiberg (DE)

(72) Inventors: Richard HEINZ, Muenchen (DE); Andrea HEINZ, Muenchen (DE); Stephan LEISENHEIMER, Deisenhofen (DE)

(73) Assignee: Infineon Technologies AG, Neubiberg (DE)

(21) Appl. No.: 17/550,246

(22) Filed: Dec. 14, 2021

(30) Foreign Application Priority Data
Dec. 23, 2020 (DE) 102020134785.5

(51) Int. Cl. G01B 7/30; G01D 5/14; G01D 5/16; G06N 3/08; G06N 3/04

(52) U.S. Cl. CPC G01B 7/30; G01D 5/145; G06N 3/04; G06N 3/08; G01D 5/16

(57) ABSTRACT

An exemplary embodiment relates to a device for training a neural network for determining a rotation angle of an object. The device is configured to receive system data via a sensor system for measuring a magnetic field in order to determine the rotation angle. The device is also configured to generate error data which includes at least one deviation of the system data from a target state of the sensor system or the strength of the components of a superimposed external magnetic field. Furthermore, the device is configured to create training data using the system data and the error data and to train the neural network using the training data.

### FIELD

Exemplary embodiments relate to a device and a method for training a neural network to determine a rotation angle of an object and to a device, a system, and a method for determining a rotation angle of an object.

### BACKGROUND

Angle sensors are often used in the automotive industry, for example for power steering systems or for anti-lock braking systems (ABS). Angle sensors comprise components such as a magnet and magnetic sensors to determine the rotation angle of a rotating object, such as a shaft. In the manufacture and assembly of angle sensors, it is usually not possible to completely avoid misalignment of the components. In addition, position deviations of the magnet and magnetic sensors can occur due to vibrations, caused, for example, by the operation of the angle sensor or the operation of neighboring devices in the environment. In addition, the high electrical currents in devices of electric vehicles can cause stray magnetic fields, which can be superimposed on the magnetic field of the angle sensor. Deviations in alignments of angle sensor components and superimposing stray magnetic fields can adversely affect the angle determination or reduce the measurement accuracy.

One way of minimizing the influence of misalignment is to use complex processes at the production level of the angle sensors. In another approach, angle sensors are calibrated to compensate for an error in the angle determination. Other methods use angle sensors that have a magnet with a larger diameter. Magnets with a larger diameter can produce a stronger magnetic field, which can reduce the error in determining the rotation angle. However, these approaches are often associated with higher production or development costs.

In order to reduce the influence of external magnetic fields, cost-intensive methods are used to ensure the shielding of the magnetic field sensor from the external environment.

Differential measurement methods with multiple magnetic sensors are used to correct the superposition of external magnetic fields. However, angle sensors with differential measurement are often even more susceptible to misalignment of angle sensor components, which in turn limits the accuracy of the rotation angle determination.

Inductive sensors can sometimes be used for more precise angle determination in the presence of stray magnetic fields. However, inductive angle sensors for a 360° angle determination are expensive and complex. In addition, these angle sensors have a higher space requirement with e.g., more than 30 mm, which is often not tolerable for many applications.

This state of affairs motivates a better design for angle sensors, in order to be able to determine rotation angles better, more precisely, with a smaller error, more easily or more cost-effectively.

### SUMMARY

This object can be achieved by the subject matter defined in the independent patent claims.

One exemplary embodiment relates to a device for training a neural network for determining a rotation angle of an object. The device is designed to receive system data via a sensor system for measuring a magnetic field in order to determine the rotation angle. Furthermore, the device is designed to generate error data which includes at least one deviation of the system data from a target state of the sensor system or the strength of the components of a superimposed external magnetic field. The device is also designed to create training data using the system data and the error data and to train the neural network using the training data. System data includes, for example, information about the geometric arrangement of magnets and magnetic sensors, the number of magnetic sensors, or the shape of the magnet of an angle sensor. Error data can be generated based on the system data. Error data can include a deviation, for example, from an ideal geometric position of the magnet or magnetic sensor or from an ideal shape of the magnet. Error data include, for example, possible misaligned arrangements of magnetic sensors relative to the magnet, or potential deviations of the shape of a ferromagnet, for example, from an ideal circular shape. In addition, the error data can include different strengths of external magnetic field components, which arise, for example, in an environment of the angle sensor and are superimposed on the magnetic field of the angle sensor. Based on the system data and the error data, training data can be provided to train an artificial neural network to determine a rotation angle. Training data can reflect a relationship between sensor data from magnetic sensors and rotation angles. The trained neural network can determine the rotation angle with a smaller error based on (error-prone) sensor data from angle sensors, which include e.g., geometric deviations or are exposed to an external magnetic field. Using the device, rotation angles can be determined with smaller errors using low-cost angle sensors that are simple (i.e., non-complex) to produce, and which include geometric deviations and/or have not been (elaborately) calibrated or shielded.

One exemplary embodiment relates to a device for determining a rotation angle of an object. The device is designed to receive sensor data from a first sensor and a second sensor of a sensor system for measuring a magnetic field. The device is also designed to determine the rotation angle by means of a trained neural network. The trained neural network uses the sensor data of the first sensor and the second sensor as input data. For example, sensor data can be provided by a first and second Hall sensor. The sensor data can include information about (a) detected magnetic field component(s) of a magnetic field in the sensor system. The magnetic field can be generated by a rotatable magnet or encoder. The trained neural network can receive the sensor data of the angle sensor and process it into output information in order to determine a rotation angle of the magnet or encoder. The neural network of the device can be trained in such a way that a rotation angle can be determined with a smaller error based on (error-prone) sensor data. (Error-prone) sensor data can be generated, for example, by an angle sensor which includes, e.g., components with a geometric deviation from a target value or is exposed to an external magnetic field. The device can be used to avoid complex production or expensive calibration or shielding of angle sensors.

One exemplary embodiment relates to a method for training a neural network for determining a rotation angle of an object. The method includes receiving system data about a sensor system for measuring a magnetic field in order to determine the rotation angle. The method also includes generating error data which includes at least one deviation of the system data from a target state of the sensor system or the strength of the components of a superimposed external magnetic field. The method also includes creating training data using the system data and the error data, and training the neural network using the training data. System data includes, for example, information about the geometric arrangement of magnets and magnetic sensors, the number of magnetic sensors, or the shape of the magnet of an angle sensor. Error data can be generated based on the system data. Error data can include a deviation, for example, from an ideal geometric position of the magnet or magnetic sensor or from an ideal shape of the magnet. Error data include, for example, possible misaligned arrangements of magnetic sensors relative to the magnet, or potential deviations of the shape of a ferromagnet, for example, from an ideal circular shape. In addition, the error data can include different strengths of external magnetic field components, which arise, for example, in an environment of the angle sensor and are superimposed on the magnetic field of the angle sensor. Based on the system data and the error data, training data can be provided to train an artificial neural network to determine a rotation angle. Training data can reflect a relationship between sensor data from magnetic sensors and rotation angles. The trained neural network can determine the rotation angle with a smaller error based on (error-prone) sensor data from angle sensors, which include e.g., geometric deviations or are exposed to an external magnetic field. Using the method, rotation angles can be determined with smaller errors using low-cost angle sensors that are simple (i.e., non-complex) to produce, and which include geometric deviations and/or have not been (elaborately) calibrated or shielded.

One exemplary embodiment of a method for determining a rotation angle of an object includes receiving sensor data from a first sensor and a second sensor of a sensor system for measuring a magnetic field. The method also includes determining the rotation angle by means of a trained neural network. The trained neural network uses the sensor data of the first sensor and the second sensor as input data. For example, sensor data can be provided by a first and second Hall sensor. The sensor data can include information about a detected magnetic field component(s) of a magnetic field in the sensor system. The magnetic field can be generated by a rotatable magnet or encoder. The trained neural network can receive the sensor data of the angle sensor and process it into output information in order to determine a rotation angle of the magnet or encoder. The neural network of the device can be trained in such a way that a rotation angle can be determined with a smaller error based on (error-prone) sensor data. (Error-prone) sensor data can be generated, for example, by an angle sensor which includes, e.g., components with a geometric deviation from a target value or is exposed to an external magnetic field. Use of the method allows complex production or expensive calibration or shielding of angle sensors to be avoided.

### BRIEF DESCRIPTION OF THE DRAWINGS

Some examples of systems and/or methods are described in more detail in the following with reference to the accompanying figures, purely as examples. In the drawings:

FIG. 1 shows an exemplary embodiment of a device for training a neural network for determining a rotation angle of an object;

FIG. 2 shows an example of a design for training a neural network for determining a rotation angle of an object;

FIG. 3 shows an example of a simulation model for creating training data;

FIG. 4 shows an example of cumulative probabilities of rotation angle errors based on deviations of system data from a target state of the sensor system;

FIG. 5 shows an example of cumulative probabilities of rotation angle errors based on deviations of system data from a target state of the sensor system and a superimposed external magnetic field;

FIG. 6 shows an exemplary embodiment of a device for determining a rotation angle of an object;

FIG. 7 shows an example of an architecture of a (trained) neural network for determining a rotation angle of an object;

FIG. 8 shows an exemplary embodiment of a system for determining a rotation angle of an object;

FIG. 9 shows a further exemplary embodiment of a system for determining a rotation angle of an object;

FIG. 10 shows an example of cumulative probabilities of rotational angle errors based on different radial distances of sensors of a sensor system;

FIG. 11 shows a further exemplary embodiment of a system for determining a rotation angle of an object;

FIG. 12 shows an example of an output of a device or system for determining a rotation angle of an object;

FIG. 13 shows a flowchart of an exemplary embodiment of a method for training a neural network for determining a rotation angle of an object; and

FIG. 14 shows a flowchart of an exemplary embodiment of a method for determining a rotation angle of an object.

### DETAILED DESCRIPTION

Some examples are now described in more detail with reference to the accompanying figures. However, other possible examples are not limited to the features of these embodiments described in detail. These can have modifications of the features as well as equivalents and alternatives to the features. In addition, the terminology used here to describe specific examples is not intended to be limiting for other examples.

Identical or similar reference signs refer throughout the description of the figures to the same or similar elements or features, which may each be implemented identically or in modified form although they provide the same or a similar function. In the figures, the thicknesses of lines, layers and/or regions may be shown exaggerated for the sake of clarity.

If two elements A and B are combined using an “or”, this should be understood to mean that all possible combinations are disclosed, i.e., only A, only B, as well as A and B, unless explicitly defined otherwise in individual cases. An alternative formulation that can be used for the same combinations is “at least one of A and B” or “A and/or B”. An equivalent formulation applies to combinations of more than two elements.

If a singular form, e.g., “a, an” and “the” is used and the use of only a singular element is neither explicitly nor implicitly defined as mandatory, then other examples may also use a plurality of elements to implement the same function. If a function is described in the following as being implemented using a plurality of elements, further examples may implement the same function by using a single element or a single processing entity. It also goes without saying that the use of the terms “comprises”, “comprising”, “has” and/or “having” precisely defines the presence of the specified features, integers, steps, operations, processes, elements, components and/or a group of the same, but not the presence or the addition of one or more other features, integers, steps, operations, processes, elements, components and/or a group of the same.

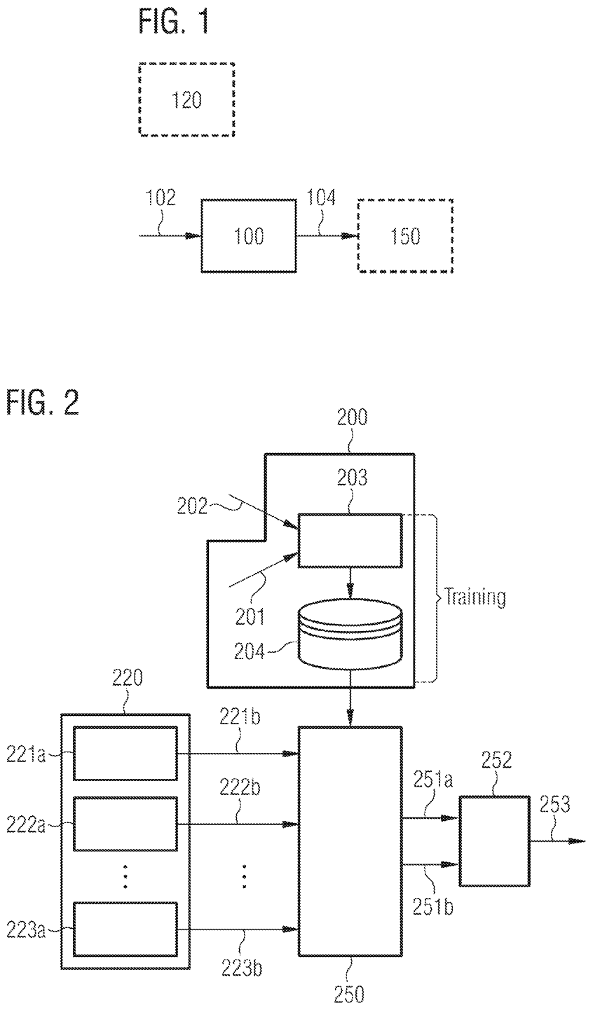

FIG. 1 shows an exemplary embodiment of a device 100 for training a neural network 150 for determining a rotation angle of an object. The device 100 is includes at least one processor configured to receive system data 102 via a sensor system 120 for measuring a magnetic field in order to determine the rotation angle. Furthermore, the at least one processor of the device 100 is configured to generate error data, which includes at least one deviation of the system data 102 from a target state of the sensor system 120 or the strength of the components of a superimposed external magnetic field. The at least one processor of the device 100 is also configured to create training data 104 by using the system data 102 and the error data and to train the neural network 150 using the training data 104.

The neural network 150 can be used to determine a rotation angle of an object based on sensor data from the sensor system 120, such as an angle sensor. The device 100 can train the neural network 150 with respect to the sensor system 120 in such a way that a rotation angle can be determined with a smaller error. A rotation angle error can occur due to (error-prone) sensor data generated by a sensor system with a (e.g., geometric or physical) configuration that deviates from a target state and/or with a superimposed external magnetic field.

A deviating configuration comprises, for example, an arrangement of magnetic sensors and magnets which due to its manufacture is offset or rotated with respect to a prescribed geometric arrangement. The sensor systems can generate (deviating) sensor data, which can lead to errors in the rotation angle determination. Deviating sensor data can arise because the magnetic field is detected at a different position than that prescribed by the magnetic sensors. In addition, an external magnetic field can be superimposed on a magnetic field of a magnet in the sensor system. Superimposed external magnetic fields can also cause the sensor system to produce deviating sensor data. Deviating sensor data can arise because, due to the interaction of the external magnetic field, the magnetic sensors detect, for example, a stronger or weaker magnetic field component (superposition of magnetic fields) than the magnetic field component applied due to the magnet of the sensor system (alone).

The device 100 can train the neural network 150 to possible deviations of the sensor system or to possible superimposed external magnetic fields with a view to angle determination with a higher accuracy or smaller error. For the training of the neural network 150, the device 100 can receive system data 102 about the sensor system 120. System data 102 includes, for example, an arrangement of magnetic sensors and magnets in the sensor system 120, the shape of the magnet, or the magnetic field strength of the magnet. The device 100 can generate error data to train the neural network 150 based on the system data 102 of the sensor system 120 and the generated error data. The error data can include possible deviations of the system data of the sensor system 120 from an ideal state. For example, error data includes possible position shifts of magnetic sensors or magnets of the sensor system or shape deviations of the magnet, e.g., from an ideal circular shape. Error data can include external, e.g., homogenous magnetic fields, which can potentially be superimposed on the magnetic field of the magnet of the sensor system. The device 100 can create training data 104 based on the system data 102 of the sensor system 120 and the generated error data. The neural network 150 can learn by training to determine a rotation angle with a higher accuracy based on sensor data of the (error-prone) sensor system 120. The device 100 can enable the determination of rotation angles with a smaller error using existing sensor systems that include deviations from a specification and/or are exposed to external magnetic fields. For example, sensor systems that have been produced with less complex and/or expensive measures for shielding or calibration can be used.

According to one example, the system data can comprise at least information about a geometric arrangement of a sensor, a magnet or an encoder of the sensor system, about a magnetic field of the magnet or the encoder, a shape of the magnet or the encoder, or about a distance between the sensor and the magnet or encoder. System data can include information about a status or configuration of the sensor system. A status of the sensor system can be determined from the geometric arrangement of components of the sensor system, such as magnetic sensors, magnets, encoders or other elements used for determining a rotation angle. A status of the sensor system can be determined from the number of magnetic sensors, magnets or magnetic elements present in an encoder. The status can be determined from the type of the magnetic sensors, e.g., 1D sensors, 2D sensors, 3D sensors, Hall sensors, inductive sensors or magnetoresistive sensors. The status can be determined from the shape and/or type of the magnet, such as a ferromagnet, dipole magnet, bar magnet, the material of the magnet, or strength of the magnetic field. The status can be determined from the type of an encoder of the sensor system. The type of the encoder can be determined from the shape or nature of the encoder disk (e.g., gear wheel, disk with magnetic segments, number/shape of segments for encoding).

Error data can include possible deviations in the system data of the sensor system from a target state. The target state can correspond to an ideal state of the sensor system. For example, error data includes various possible geometric coordinates of a magnetic sensor that has been displaced, rotated or tilted from an ideal position. For example, error data includes angular deviations between a first magnetic sensor and a second magnetic sensor, or a magnetic sensor and a magnet. Error data can represent potential deviations in a sensor system that occur during the production of the sensor system, for example, and cannot be avoided. Error data can also represent potential deviations in a sensor system that can occur due to aging over the course of the operation of the sensor system. Aging-related deviations can occur, for example, due to wear of mechanical components or a gradual weakening of the magnetic field of the magnet.

Error data can alternatively or additionally include the strength of the components of an external magnetic field that can potentially be superimposed on the magnetic field of the magnet of the sensor system. For example, external magnetic fields can be homogenous magnetic fields that can occur in the environment of the sensor system, for example, in the operation of electric vehicles. The external magnetic field can also be, for example, static, non-homogenous or a temporally varying (e.g., at low frequency) alternating field.

According to one example, the error data can be generated within a tolerance range, so that the deviation of the system data from the target state and the strength of the components of the external magnetic field do not exceed a critical limit. The tolerance range can be determined by an inaccuracy due to the manufacture of the sensor system or due to a measurement inaccuracy of the sensors of the sensor system. Error data can be generated within the tolerance range to include possible (e.g., probable or predictable) deviations of the system data from a target state. The tolerance range can be determined by the (magnetic) environment of the sensor system. Error data can be generated within the tolerance range to include possible superimposed external magnetic fields that are more likely to occur due to electrical equipment near the sensor system. For example, the error data can be limited by the tolerance range to a maximum deviation of the system data from the target state of the sensor system or to a maximum possible magnetic field strength of a superimposed external magnetic field. Error data can generally be generated (within the tolerance range) with a random distribution.

Based on the system data and the error data, the device 100 can create training data 104. Using the training data 104, the neural network 150 can be trained to be able to determine the rotation angle of the object more accurately or with a smaller error.

According to one example, training data can be created using a simulation model. The simulation model can be created based on the system data of the sensor system, such as geometries of the magnet, positions of magnets and magnetic sensors, magnetic field strength of the magnet, or distances between the magnetic sensors and the magnet. The status of the sensor system can be influenced by a deviation of each system parameter (in isolation). In the simulation model, for each system parameter, such as the position of the magnet in the X direction, an error, such as a geometric displacement by ΔX, can be defined in order to describe a deviation from an ideal target state of the sensor system in each case. Other errors include, for example, position displacements of the magnet in the Y and/or Z direction with respect to a common Cartesian coordinate system in the sensor system, position displacements of the magnetic sensors, etc. In the simulation model, offset errors of magnetic field strengths can alternatively or additionally be determined.

The simulation model can be used to create training data. According to one example, the training data can be created based on a plurality of combinations of error data with respect to the system data, in order to obtain sensor data and a rotation angle for each combination. In the training data, sensor data and a (correct, to be learned) rotation angle can be assigned for each combination of error data. Using the training data, rotation angles can be determined with a smaller error for any possible combination of error sources.

According to another example, the training data can be created based on a plurality of combinations of error data with respect to the system data, in order to obtain sensor data and an output for each combination in order to use the output to determine a rotation angle. In the training data, sensor data and an output, such as new sensor data, can be assigned for each combination of error data. New sensor data (output of the neural network) can differ from the sensor data (input of the neural network) in such a way that a correct rotation angle (compensated for geometric deviations and/or superimposed external magnetic fields) can be assigned.

For example, the sensor data includes information about a magnetic field component of the magnetic field to be detected by the sensors of the sensor system. Sensor data can include, for example, information on magnetic field components Bxₙ, Byₙ and Bzₙ for each magnetic sensor n of the sensor system.

For example, the neural network can be trained by supervised learning and the training data. Within the training process, the neural network can learn parameters such as weights between the neurons, e.g., by error back-propagation.

Further details and optional aspects of the device 100 for training a neural network to determine a rotation angle of an object are described in conjunction with the proposed design or with one or more of the examples described below.

FIG. 2 shows a schematic diagram of a design for training a neural network 250 for determining a rotation angle of an object. The neural network 250 is trained with training data 204, which was created e.g., by a device 200 for training a neural network 250. As shown by way of example, the training data 204 is created using a simulation model 203 running on at least one processor. In the example, the simulation model 203 uses system data 202, such as the shape of a magnet, position of the magnet and of sensors. Furthermore, the simulation model 203 uses error data 201, such as geometric deviations, external stray magnetic fields, deviations from a magnetic field strength of the magnet, etc. The training of the neural network 250 using the training data 204 can be called the training phase.

The determination of the rotation angle by means of the trained neural network 250 can be called the application phase. In the application phase, the trained neural network 250 can receive sensor data 221b, 222b, 223b etc. from a sensor system 220 with n sensors such as 221a, 222a and 222b etc. Sensor data, such as 221b of the first sensor 221a, include, for example, information about measured magnetic field components Bx₀, By₀ and Bz₀. The trained neural network 250 can use the sensor data 221a, 222a, 223a, etc. to predict two phase-shifted signals 251a-b (output), such as sine and cosine signals. The phase-shifted signals 251a-b can be used to determine the rotation angle 253 according to an algorithm for angle determination 252, e.g., using an arc tangent function.

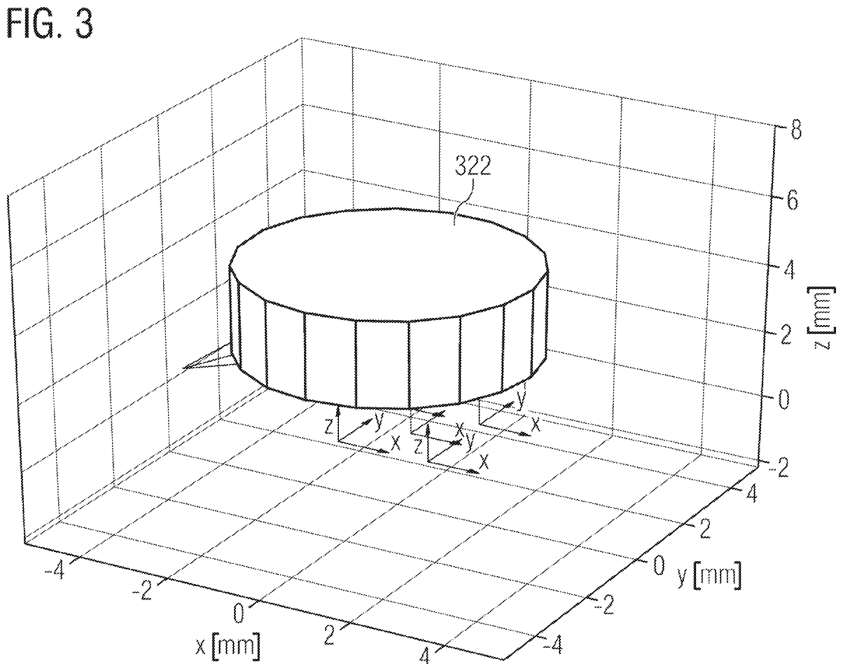

FIG. 3 shows an example of a simulation model (Python, “magpylib” package) for simulating a magnetic field of a magnet 322, which is shifted in its position within a tolerance range. A diametrically magnetized magnet is used for the magnetic field simulation. The magnet 322 used in the simulation model has a height of 25 mm and a diameter of 6 mm. The generation of error data and training data is not limited to the above examples. Embodiments are only intended to provide a better understanding of the described design.

In another example, training data can be created experimentally, e.g., by a plurality of different geometric arrangements of sensors or magnets of the sensor system.

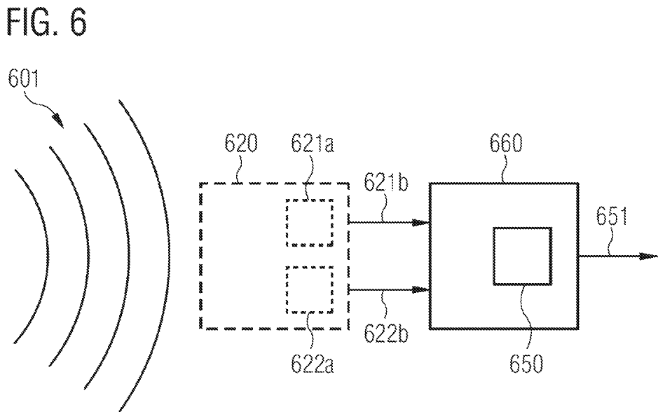

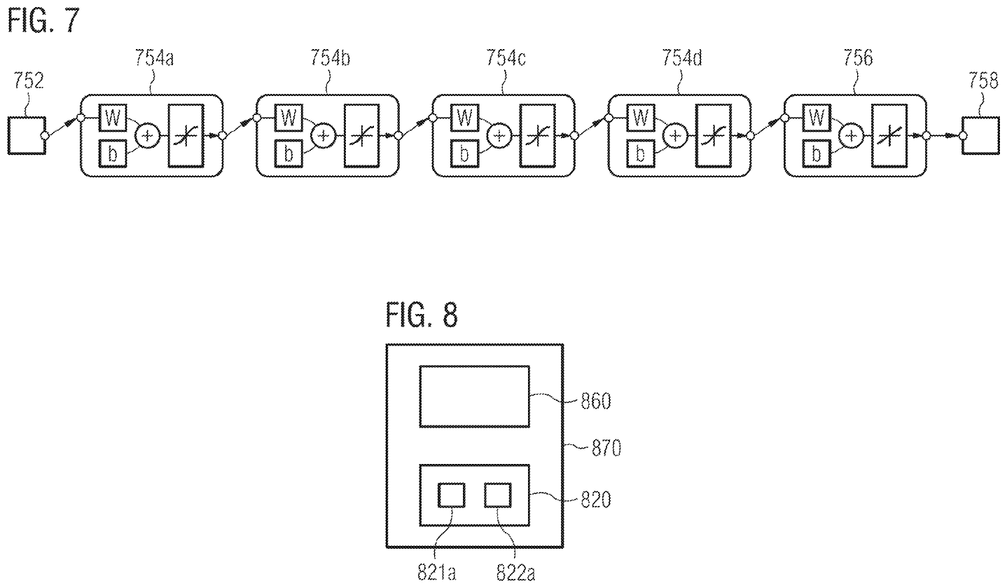

Further details and examples of embodiments for the neural network are described in more detail in conjunction with FIG. 6-7 and for the sensor system in conjunction with FIG. 8-11.

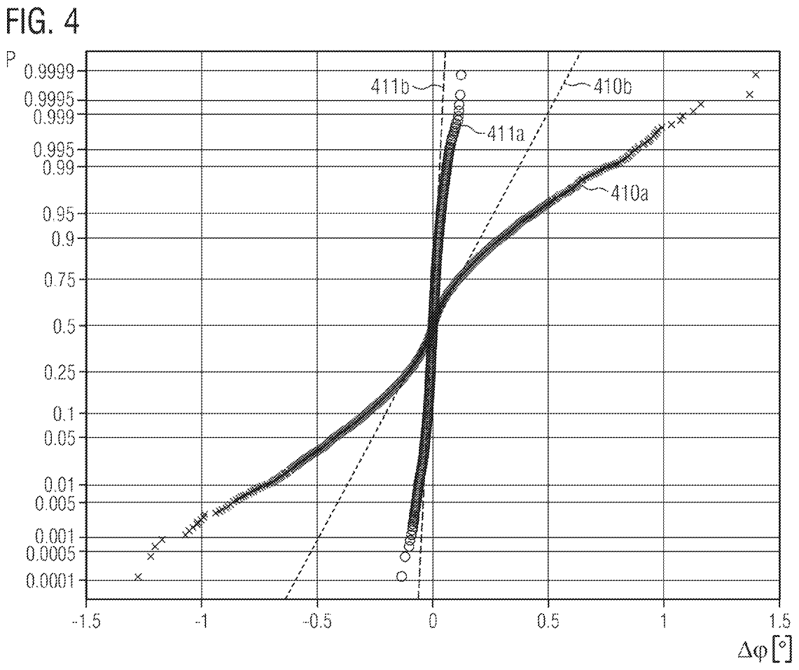

FIG. 4 shows example cumulative probabilities P of rotation angle errors Δφ based on (e.g., simulated) deviations of system data from a target state. In FIG. 4, cumulative probabilities of rotation angle errors with and without using the device 100 for training a neural network to determine a rotation angle are compared.

The curve labeled 410a was created using a reference system with a reference sensor system. The reference sensor system was placed below a center of a rotatable magnet. For example, the center of the magnet is determined by the axis around which the magnet can be rotated. Rotation angles of the magnet were determined by means of the reference system without the use of the device 100. The reference system was not trained with training data. Sensor data of the reference sensor were determined using an algorithm for rotation angle determination (e.g., by applying an arc tangent function).

The curve labeled 411a was created using a sensor system and a device (e.g., 100, 200) for training a neural network. The sensor system was placed below a center of a rotatable magnet. For the determination of the rotation angle, a neural network was used which was trained on the sensor system by means of the device. An output of the trained neural network was used to determine the rotation angle (e.g., by applying an arc tangent function).

In the example shown, the neural network is trained to determine the rotation angle for a deviation of system data from a target state. Deviations of system data from a target state can also be described as mechanical tolerances in the following comments. The following table shows examples of possible deviations of system data from a target state within a tolerance range, that were used to create the training data.

TABLE 1

| Sensor X displacement | −0.3 . . . 0.3 | mm |
|---|---|---|
| Sensor Y displacement | −0.3 . . . 0.3 | mm |
| Sensor inclination (random direction) | −3 . . . 3° | |
| Magnet X displacement | −0.3 . . . 0.3 | mm |
| Magnet Y displacement | −0.3 . . . 0.3 | mm |
| Magnet inclination (random direction) | −3 . . . 3° | |
| Distance between sensor and magnet | 2.2 . . . 2.8 | mm |
| Magnetization of magnet | 1100 . . . 1400 | mT |

As shown in the examples of Tab. 1, deviations of system data from a target state (mechanical tolerances) include a displacement of a magnetic sensor and/or a magnet in a first direction (X-axis) and/or a second direction (Y-axis) and/or an inclination (or tilt), e.g., with respect to a third direction (Z-axis) in terms of a Cartesian coordinate system. In addition, deviations relate to the distance between the magnetic sensor and the magnet and to a magnetization of the magnet. Magnetizations of the magnet refer, for example, to the magnetic field strength of the magnet with regard to various magnetic field components (e.g., x component, y component, z component) or the orientation of the magnetic field (direction of the magnetic field lines).

In addition, the neural network was trained with regard to a homogenous, external magnetic field:

TABLE 2

| | |
|---|---|
| Stray field (random direction) | −6 . . . 6 mT |

Based on the possible sources of error given in Tab. 1 and Tab. 2, training data was created using the device. An output of the trained neural network was used to determine the rotation angle.

Rotation angle errors of the two probabilities 410a, 411a are related to a correct rotation angle, which is known from the simulation model used. The rotation angle error is given by the difference between the predicted rotation angle and the correct rotation angle. The dashed curves 410b, 411b each give a measure of the scatter and are based on the interquartile range. FIG. 4 shows that rotation angle errors can be significantly reduced by means of the device for training a neural network for determining a rotation angle. Rotational angle errors determined by the trained neural network are in the range of approximately [−0.2°; 0.2° ]. Rotation angle errors determined using the reference system significantly exceed this range.

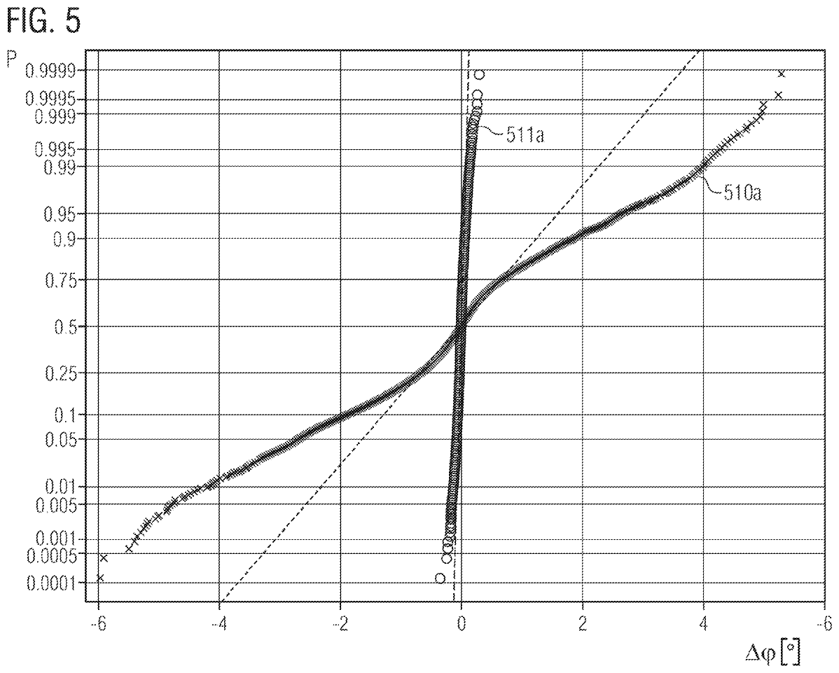

FIG. 5 shows examples of cumulative probabilities 510a, 511a of rotation angle errors Δφ additionally with (simulated) superimposed external magnetic fields. Compared to FIG. 4, the accuracy of the rotation angle determination by means of the reference system decreases while the accuracy of the rotation angle determination using the trained neural network increases. It follows that by means of the training, the neural network can learn to correct an output with regard to occurring homogenous stray field present (at least partially) for the rotation angle determination.

The device can train a neural network to determine a rotation angle in a specific way, e.g., with regard to a (more or less limited) tolerance range, to the type of system deviations or to an environment of the sensor system. The environment of the sensor system can be determined by electrical currents, ambient temperatures, vibrations, or generally by physical states that may influence a measurement of the sensor system.

The device can train a neural network to determine a rotation angle specifically for a type of sensor system. Neural networks can differ in their input parameters, for example, depending on the sensor system for detecting a magnetic field. The device is not limited to a specific type of (system data of a) sensor system and/or to a training of a specific neural network. Training data created by the device for training the neural network can differ, for example, in the scope or type or number of input and/or output parameters.

Further details and optional aspects of the device (e.g., 100, 200) for training a neural network to determine a rotation angle of an object are described in conjunction with the proposed design or with one or more of the examples described below.

FIG. 6 shows an exemplary embodiment of a device 660 for determining a rotation angle of an object. The device 660 is configured to receive sensor data 621b, 622b of a first sensor 621a and a second sensor 622a of a sensor system 620 for measuring a magnetic field 601. The device 660 is also configured to determine the rotation angle by means of a trained neural network 650. The trained neural network 650 uses the sensor data 621b, 622b of the first sensor 621a and the second sensor 622a as input data.

The sensor system 620 can be configured to be similar or identical to the sensor system 120 in FIG. 1 or 220 in FIG. 2. The sensor system 620 can be (part of) an angle sensor and detect the magnetic field 601 by means of the magnetic sensors 621a and 622a, such as Hall sensors. The sensor system 620 can generate sensor data 621b, 622b based on the measurement of the magnetic field 601. Sensor data can be based on a measurement of magnetic field components of the magnetic field 601 by means of the first and second sensors. Sensor data can include information about measured magnetic field components, such as B_{X}, B_{Y}, B_{Z} for the first sensor 621a and the second sensor 622a. The trained neural network 650 can be implemented in the device 660 as an integrated circuit, for example. The trained neural network 650 can be configured to be similar or identical to the neural network 150 in FIG. 1 (or 250 in FIG. 2). The trained neural network 650 may have been trained by means of the device 660 for training a neural network (e.g., 100, 200). The neural network 650 can use the sensor data 621b, 622b as input data and can generate an output to determine a rotation angle based on this data. The neural network 650 can use sensor data 621b, 622b from the sensor system 620, which includes deviations from a target state and/or is exposed to an external magnetic field. Using the sensor data 621b, 622b of the sensor system 620, the neural network 650 can generate an output 651, such as new sensor data, in order to determine a rotation angle with a smaller error. According to another example, the neural network 650 can output the rotation angle directly based on the sensor data 621b, 622b of the sensor system 620.

For example, the trained neural network 660 may have been trained using system data about the sensor system 620 and error data. The error data can include at least one deviation of the system data from a target state of the sensor system or the strength of the components of a superimposed external magnetic field. Deviations of system data from a target state of the sensor system 620 include, for example, geometric displacements of the first sensor 621a, of the second sensor 622a e.g., relative to each other, relative to a specified position in the sensor system 620, or relative to an object (e.g., magnets or encoders) that generates the magnetic field 601. The external magnetic field is, for example, a homogenous magnetic field which interacts with the magnetic field 601. Further details on the training of the trained neural network may refer to the previous comments in connection with FIGS. 1-3 and Tables 1-2.

Further details and optional aspects of the device 660 for determining a rotation angle of an object are described in conjunction with the proposed design or with one or more of the examples described above or below.

FIG. 7 shows an example architecture of the (trained) neural network 650 for determining a rotation angle of an object. According to the example, the neural network comprises four hidden layers 754a-d between an input layer 752 and an output layer 756. The input layer 752 is configured to receive the sensor data 621a, 622a of the sensor system 620 and the output layer 756 is configured to output an output 758 for the determination of the rotation angle.

The hidden layers 754a-d, also known as intermediate layers, can have weights w and threshold values b (bias), which can be initialized to specific values before the neural network training. During the training of the neural network, the parameters w and b can be adjusted or trained (e.g., using linear regression) with a view to providing a more reliable prediction of the rotation angle. As shown in the examples, the neural network can be a multilayer neural network (deep neural network). For example, the neural network can have 50 neurons in the first hidden layer 754a, 25 neurons in the second hidden layer 754b, 20 neurons in the third layer 754c, and 10 neurons in the fourth layer 754d.

In the input layer 752, the neural network can receive sensor data, such as n×m measurement data, where n corresponds to the number of sensors in a sensor system and m corresponds to the number of measurable magnetic field components. For example, a neural network trained on a sensor system with four 3D Hall sensors, can use 4×3=12 input parameters to create the 758 output for determining the rotation angle. In the output layer 756, cosine and sine functions or any phase-shifted functions can be output (or predicted) in order to determine the rotation angle using an algorithm for determining a rotation angle.

For example, the rotation angle can be determined using the sensor data and by applying an arc tangent function. For example, a circuit of the sensor system can use the output of the neural network to determine the (more reliable) rotation angle based on an algorithm integrated in the sensor system.

As shown in the examples, the neural network can have a feed-forward architecture. Information from the input layer can be passed through the intermediate layers to the output layer along one direction. In another example, the neural network may have a recurrent network architecture, in which, for example, additional connections exist, so that information can pas through regions of the network backwards, in multiple directions, or repeatedly.

The designs described here are not limited to the examples of neural networks mentioned above. The device for training a neural network and the device for determining a rotation angle as well as systems for determining rotation angles can use neural networks of a different type.

FIG. 8 shows an exemplary embodiment of a system 870 for determining a rotation angle of an object. The system 870 comprises a device 860 for determining a rotation angle of an object according to a design from the preceding embodiments. The system 870 also comprises a sensor system 820 for measuring the magnetic field. The sensor system 820 comprises at least one first sensor 821a and one second sensor 822a. The sensor system 820 can be configured similarly or identically to one of the sensor systems described above or below (such as 120, 220, 620 or 920). The system 870 can detect a magnetic field in the environment of the sensor system 820 using the sensor system 820 and generate sensor data, for example. The device 860 can receive the sensor data, process it and generate an output. For example, the output can include new sensor data or phase-shifted angle functions based on the sensor data to determine a rotation angle. In another example, the device 860 can output the rotation angle directly.

In general, the sensor system 820 can comprise any number of sensors, such as one or more 2D or 3D Hall sensors, to measure a magnetic field in the environment of the sensor system 820 for determining a rotation angle of an object. The object can be rotatably mounted. For example, the object can be a magnet or an encoder (of the sensor system 820) or any object (such as a shaft) that is coupled to the magnet or encoder of the sensor system 820. A rotation of the object can create an alternating magnetic field. The alternating magnetic field can be detected by the sensor system 820.

The state of the rotatably mounted object can be determined from the rotation angle. The rotation angle can describe an angular position of the object. Rotation angles can relate, for example, to an initial rotation angle (e.g., before operation of a system or before rotation of the object) or to an absolute rotation angle of the object (e.g., reference position of the magnet or the encoder).

Further details and optional aspects of the system 870 for determining a rotation angle of an object are described in conjunction with the proposed design or with one or more of the examples described below.

In another exemplary embodiment, the system for determining a rotation angle also comprises a third sensor for measuring the magnetic field. The third sensor can be the same, similar, or different in comparison to the first or second sensor. Sensor data can include information from the third sensor and can be used to determine the rotation angle.

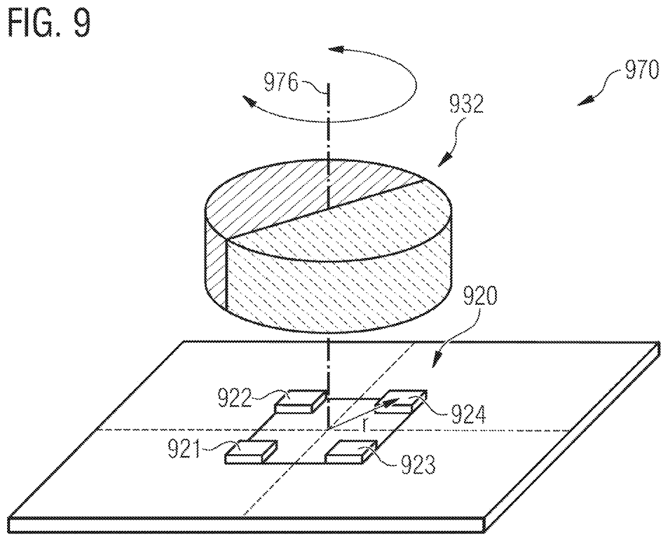

FIG. 9 shows an exemplary embodiment of a system 970 for determining a rotation angle of an object with a sensor system 920 comprising four sensors 921-924. Compared to the previous embodiments, the sensor system 920 also comprises a fourth sensor 924 for measuring the magnetic field. The fourth sensor 924 can be the same, similar, or different in comparison to the first sensor 921, the second sensor 922 and/or the third sensor 923. Sensor data can include information from the fourth sensor 924 and can be used for determining a rotation angle.

The table below shows a comparison between a reference system (without training of a neural network (NN)) and (trained) systems for determining a rotation angle with a different number of sensors in the sensor system with regard to rotation angle errors. The rotation angle was determined by means of the reference system using an arc tangent function and with a sensor positioned underneath a rotatable magnet.

TABLE 3

| | Rotation Angle | Maximum | |
|---|---|---|---|
| | Error Standard | Rotation | Size of |
| Number of | Deviation | Angle Error | the NN |
| sensors | [°] | [°] | (Parameters) |
| Reference | 0.743 | 4.39 | — |
| 1 | 1.074 | 6.80 | 2227 |
| 2 | 0.141 | 1.37 | 2377 |
| 3 | 0.073 | 0.48 | 2527 |
| 4 | 0.063 | 0.62 | 2677 |
| 5 | 0.063 | 0.62 | 2827 |
| 6 | 0.062 | 0.50 | 2977 |

As shown in the examples, the (trained) system with 2 sensors can determine a rotation angle with a smaller error compared to the reference system and to the (trained) system with a single sensor. For more than two sensors of the (trained) system, the rotation angle error can decrease further. This means that a system with a sensor system having more than two sensors can determine rotation angles more accurately, more reliably or with smaller errors.

The sensors can be 3D Hall sensors or magnetoresistive (e.g., AMR, GMR, TMR) sensors. In another example, sensors of the sensor system can be e.g., 1D Hall sensors, 2D Hall sensors or inductive sensors. The sensors of the sensor system can be configured in any desired way to detect a magnetic field in the environment.

FIG. 9 shows an example of the hardware of the system for determining a rotation angle. According to the exemplary embodiment, the system 970 also comprises a magnet 932 which has an axis 976 around which the magnet 932 can be rotated. The axis 976 is perpendicular to a sensor plane on which the sensors 921-924 are arranged. The magnet 932 is spaced apart from the sensor plane along the axis. The rotatable arrangement of the magnet can be used to generate an alternating magnetic field that can be detected by the sensors 921-924 of the sensor system 920. For example, the magnet can be a dipole magnet as shown, or can have a plurality of magnetic poles. The magnet can be circular or have a different shape, such as a rectangular, square, or elliptical shape.

According to another exemplary embodiment, the system 970 can alternatively or additionally comprise an encoder. The encoder can comprise a plurality of segments which include cavities or magnetic elements, for example. A rotation of the encoder can generate an alternating magnetic field or induce an alternating magnetic field by its influence on an existing magnetic field.

The distance between the magnets (or encoders) can affect the rotation angle error. For example, the distance may be less than 3 mm, less than 2.5 mm, less than 2 mm, less than 1.5 mm, or less than 1 mm. The sensors 921-924 can span a common surface that includes the sensor plane.

As shown in the example of FIG. 9, the sensors can be arranged on the sensor plane, each at the same radial distance r from the axis 976. An arrangement with equal radial distances can be advantageous for determining the rotation angle, e.g., for reasons of symmetry. Furthermore, in an arrangement with equal radial distances, better sensor data (amplification, compensation of stray fields, reduction of noise) can be generated. The radial distance can extend on the sensor plane from the axis 976 to a center of each sensor 921-924. For example, the radial distance from the axis 976 may be less than or equal to 4 mm, less than or equal to 3 mm, less than or equal to 2 mm, less than or equal to \sqrt{2} mm, or less than or equal to 1 mm. The radial distance can affect the rotation angle error.

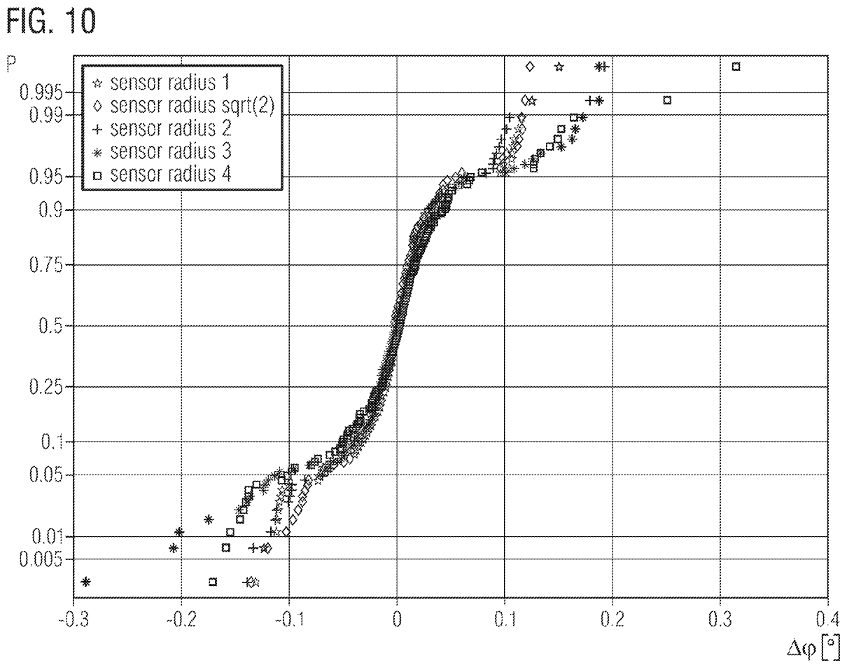

FIG. 10 shows examples of cumulative probabilities of rotation angle errors which were determined by (trained) systems with sensor systems having different radial distances between sensors. Rotation angle errors were determined with a device for determining a rotation angle having a neural network of the architecture as described in connection with FIG. 7. FIG. 10 shows cumulative probabilities with radial distances of r=1 mm, r=\sqrt{2} mm, r=2 mm, r=3 mm, and r=4 mm. FIG. 10 shows that with increasing radial distance the rotation angle error can increase. Sensors arranged at too small a radial distance can also give rise to an increase in the rotation angle error. In the example shown in FIG. 10, a (trained) system with a radial distance of \sqrt{2} mm has a smaller rotation angle error than the (trained) systems shown with a larger or smaller radial distance.

In another example, the axis 976 can also be implemented differently to that shown in FIG. 9. The axis can be implemented horizontally, or generally at a different angle. The sensor plane can be shifted along the axis or shifted along a surface perpendicular to the axis 976. In general, designs of devices for training a neural network or of systems or devices for determining a rotation angle are not limited to the type of sensor system. The designs described here can be used, for example, with sensor systems with an arrangement offset from the shaft (out of shaft configuration) with respect to the axis of rotation. In this arrangement, the sensor system may be located next to the magnet or encoder if the end of the magnet or a shaft cannot be reached along the axis of rotation, for example. The sensor system can detect, for example, a magnetic field with respect to a magnetic component, e.g., B_{X}, and generate (phase-shifted) sensor data with respect to this magnetic component.

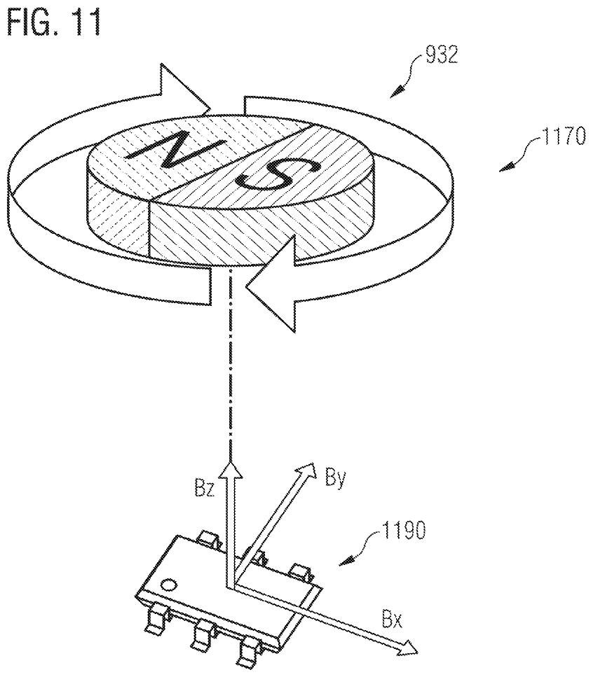

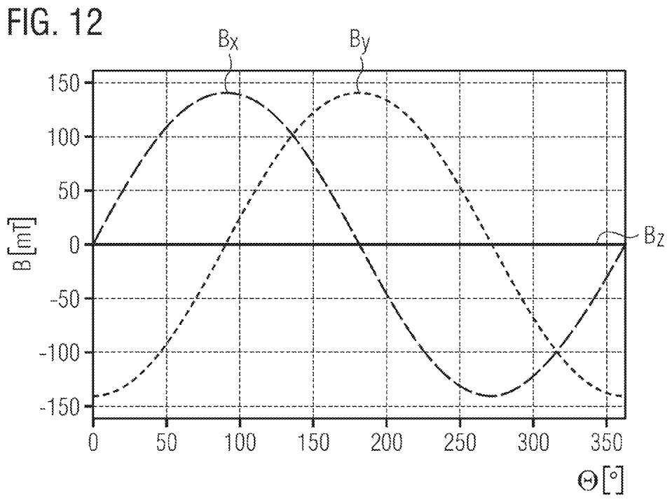

In one example, the device for determining a rotation angle and the sensor system can be integrated in a common chip. FIG. 11 shows an exemplary embodiment of a system 1170 for determining a rotation angle, having a chip 1190 and a rotatable magnet 932. The chip 1190 can comprise integrated circuits to generate output based on sensor data in order to determine rotation angles. FIG. 12 shows an example of an output of the chip 1190 as a function of a phase θ for the arrangement shown in FIG. 11. For example, a rotation angle φ can be determined using the relationship arctan 2 (B_{X}, B_{Y}).

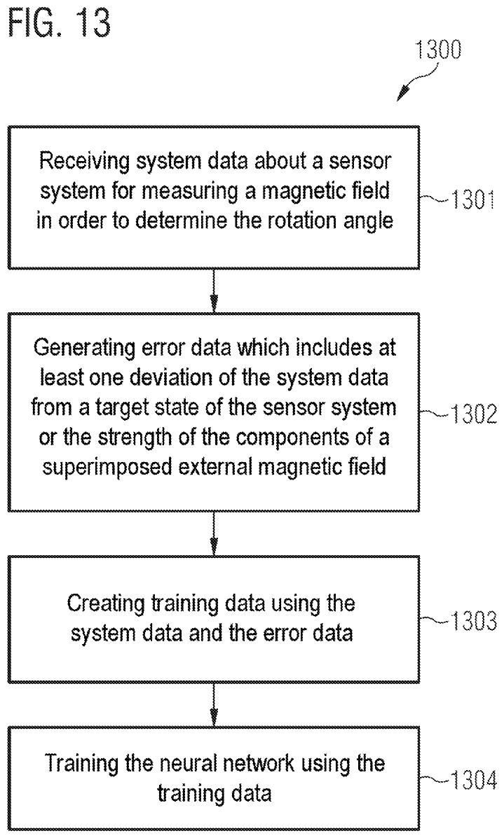

FIG. 13 shows an exemplary embodiment of a method 1300 for training a neural network for determining a rotation angle of an object. The method comprises receiving 1301 system data about a sensor system for measuring a magnetic field in order to determine the rotation angle. The method 1300 also comprises generating 1302 error data, which includes at least one deviation of the system data from a target state of the sensor system or the strength of the components of a superimposed external magnetic field. In addition, the method 1300 comprises creating 1303 training data using the system data and the error data and training 1304 the neural network using the training data.

Additional details and optional aspects of the method 1300 for training a neural network for determining a rotation angle of an object are described in conjunction with the proposed design or one or more of the examples described above or below.

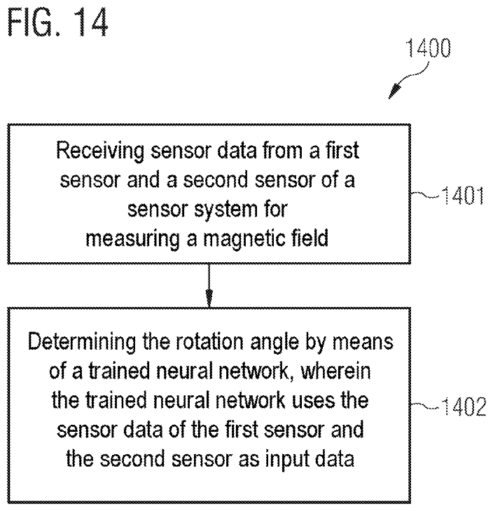

FIG. 14 shows an exemplary embodiment of a method 1400 for determining a rotation angle of an object. The method 1400 comprises receiving 1401 sensor data from a first sensor and a second sensor of a sensor system for measuring a magnetic field. In addition, the method 1400 comprises determining the rotation angle by means of a trained neural network. The trained neural network uses the sensor data of the first sensor and the second sensor as input data.

Additional details and optional aspects of the method 1300 for training a neural network for determining a rotation angle of an object are described in conjunction with the proposed design or one or more of the examples described above or below.

Another exemplary embodiment relates to a computer program with program code which executes a method as claimed in any one of the preceding embodiments using a programmable processor.

Some examples may refer to magnetic angle sensors. The proposed designs can be used individually or in combination, e.g., at the product or system level. For example, a device for training a neural network can be applied to a microcontroller in which a neural network is implemented.

Training data for training the neural network can be specifically matched to a magnet of a sensor system. For a sensor system with a different magnet (e.g., with a different size, shape, different magnetic field strength), different training data can be created to train a neural network on the given sensor system.

The aspects and features which are described together with a specific one of the previously outlined examples can also be combined with one or more of the other examples in order to replace an identical or similar feature of this other example or to introduce the feature into the other example as an addition.

Examples can also be or relate to a computer program having a program code for executing one or more of the above methods when the computer program is executed on a computer or processor. Steps, operations, or processes of various methods described above can thus also be executed by programmed computers or processors. Examples can also include program storage devices, such as digital data storage media, which are readable by machines, processors or computers and can encode or contain machine-executable, processor-executable or computer-executable programs and instructions. The program storage devices can comprise or be, for example, digital memories, magnetic storage media such as magnetic disks and magnetic tapes, hard disk drives, or optically readable digital data storage media. Other examples can also cover computers, processors or control units that are programmed to execute the steps of the methods described above, or (field-) programmable logic arrays ((F)PLAs) or (field) programmable gate arrays ((F)PGA), which are programmed to execute the steps of the methods described above.

It also goes without saying that the disclosure of a plurality of steps, processes, operations, or functions disclosed in the description or the claims should not be interpreted as being necessarily configured to be in the specified order, unless this is explicitly or implicitly stated otherwise, for example, for technical reasons. Therefore, the preceding description does not limit the performance of multiple steps or functions to a specific order. Also, in some examples a single step, a single function, process or operation can include a plurality of sub-steps, sub-functions, sub-processes or sub-operations and/or be broken down into the same.

In addition, the following claims are hereby incorporated into the detailed description, where each claim can stand for a separate example in itself. It is also important to note that, although a dependent claim in the claims may relate to a specific combination with one or more other claims, other examples may also comprise a combination of the dependent claim with the subject matter of any other dependent or independent claim. Such combinations are explicitly proposed herewith, except where it is specified in individual cases that a certain combination is not intended. In addition, features of a claim should also be included for any other independent claim, even if this claim is not directly defined as being dependent on this other independent claim.

1. A device for training a neural network for determining a rotation angle of an object, the device comprising:
at least one processor configured to:
receive system data about a sensor system for measuring a magnetic field to determine the rotation angle;
generate error data which includes at least one deviation of the system data from a target state of the sensor system or a magnetic field strength of a plurality of magnetic field components of a superimposed external magnetic field;
create training data using the system data and the error data; and
train the neural network using the training data.

2. The device as claimed in claim 1, wherein the system data comprises at least information about a geometric arrangement of a sensor, a magnet or an encoder of the sensor system, a magnetic field of the magnet or the encoder, a shape of the magnet or the encoder, or a distance between the sensor and the magnet or the encoder.

3. The device as claimed in claim 1, wherein the error data is generated within a tolerance range so that the deviation of the system data from the target state and the magnetic field strength of the plurality of magnetic field components of the external magnetic field do not exceed a corresponding critical limit.

4. The device as claimed in claim 1, wherein the at least one processor is configured to generate the training data using a simulation model.

5. The device as claimed in claim 1, wherein the at least one processor is configured to generate the training data based on a plurality of combinations of error data with respect to the system data to obtain sensor data and a rotation angle for each combination.

6. The device as claimed in claim 5, wherein the sensor data includes information about a magnetic field component of the magnetic field to be detected by sensors of the sensor system.

7. A device for determining a rotation angle of an object, the device comprising:
a sensor interface configured to receive sensor data from a first sensor and a second sensor of a sensor system for measuring a magnetic field; and
a trained neural network configured to determine the rotation angle, wherein the trained neural network uses the sensor data of the first sensor and the second sensor as input data.

8. The device as claimed in claim 7, wherein the trained neural network has been trained using system data about the sensor system and error data, wherein the error data comprises at least one deviation of the system data from a target state of the sensor system or a strength of a plurality of magnetic field components of a superimposed external magnetic field.

9. The device as claimed in claim 7, wherein the sensor data is based on a measurement of magnetic field components of the magnetic field by means of the first and second sensors.

10. The device as claimed in claim 7, wherein the trained neural network comprises four hidden layers between an input layer and an output layer, the input layer being configured to receive the sensor data of the sensor system and the output layer being configured to output an output for the determination of the rotation angle.

11. The device as claimed in claim 10, wherein the trained neural network has a feed-forward architecture.

12. The device as claimed in claim 10, wherein the trained neural network is configured to determine the rotation angle by using the sensor data and applying an arc tangent function.

13. A system for determining a rotation angle of an object, the system comprising:
a sensor system configured to measure a magnetic field, the sensor system comprising at least one first sensor and a second sensor;
a sensor interface configured to receive sensor data from the at least one first sensor and the second sensor; and
an integrated circuit comprising a trained neural network configured to determine the rotation angle, wherein the trained neural network uses the sensor data of the at least one first sensor and the second sensor as input data.

14. The system as claimed in claim 13, further comprising:
a magnet having an axis around which the magnet can be rotated, the axis being perpendicular to a sensor plane on which the at least one first sensor and the second sensor are arranged, the magnet being spaced apart from the sensor plane along the axis.

15. The system as claimed in claim 13, wherein the sensor system further comprises a third sensor for measuring the magnetic field.

16. The system as claimed in claim 15, wherein the sensor system further comprises a fourth sensor for measuring the magnetic field.

17. The system as claimed in 16, wherein the at least one first sensor, the second sensor, the third sensor, and the fourth sensor are each arranged on the sensor plane at an equal radial distance from the axis.

18. The system as claimed in claim 13, wherein the at least one first sensor and the second sensor are 3D Hall sensors or magnetoresistive sensors.

19. The system as claimed in claim 13, wherein the sensor interface, the integrated circuit comprising the trained neural network, and the sensor system are integrated in a common chip.

20. A method for training a neural network for determining a rotation angle of an object, comprising:
receiving system data about a sensor system for measuring a magnetic field in order to determine the rotation angle,
generating error data, which includes at least one deviation of the system data from a target state of the sensor system or magnetic field strength of a plurality of magnetic field components of a superimposed external magnetic field;
generating training data using the system data and the error data; and
training the neural network using the training data.

21. A method for determining a rotation angle of an object, comprising:
receiving sensor data from a first sensor and a second sensor of a sensor system for measuring a magnetic field; and
determining the rotation angle by means of a trained neural network, wherein the trained neural network uses the sensor data of the first sensor and the second sensor as input data.

22. A non-transitory computer-readable medium comprising a computer program having a program code for causing a programmable processor to execute a method for training a neural network for determining a rotation angle of an object, the computer program comprising the steps of claim 20.
